(19) United States
(12) Patent Application Publication
(10) Pub. No.: US 2012/0066027 A1
(43) Pub. Date: Mar. 15, 2012

(54) METHOD OF DISSEMINATION OF INFORMATION ABOUT A PRODUCT OR SERVICE TO IMPROVE AWARENESS OF CONSUMERS AND/OR USERS

(75) Inventor: Nikolay Melnik, Kiev (UA)

(73) Assignee: SANOFI-AVENTIS DEUTSCHLAND GMBH, FRANKFURT AM MAIN (DE)

(21) Appl. No.: 13/212,315

(22) Filed: Aug. 18, 2011

(30) Foreign Application Priority Data
Sep. 13, 2010 (UA) U201010957

(51) Int. Cl. G06Q 10/00

(52) U.S. Cl. 705/7.32

(57) ABSTRACT

The utility model relates to methods of marketing and social researches, while informing consumers and/or users in respect of a specific product or service with using telecommunications devices of communication.

The method includes manufacturing of materials containing the information on carrying out a survey, their distribution among prospective consumers or users of a product or service, who are subscribers of devices of telecommunication means of communication, receipt of a message containing a request and/or confirmation of consent to participate in the survey from the subscriber's device of telecommunication means of communication, sending a message containing a query or task relating to a product or service to the subscriber's device of telecommunication means of communication, receipt of a message containing the subscriber's reply to the query or task relating to a product or service from the subscriber's device of telecommunication means of communication. The subscriber's reply to the query or task relating to a product or service is assessed, a message containing the information about providing the subscriber with an award according to the results of the subscriber's reply to the query and/or task is sent, a database containing at least the information about the subscribers that made a request to participate in the survey is formed, a subscriber is informed about a possibility to address the interactive voice system IVR with a request for provision of reference information on the query and/or task relating to a product or service, received by him, the subscriber is provided, through the interactive voice system IVR, with the reference information on the query and/or task relating to a product or service as a response to the subscriber's request.

Thus, use of the claimed method shall ensure the creation and/or improvement of state of awareness of a subscriber being a prospective consumer and/or user in respect of a product or service.

### CROSS REFERENCE TO RELATED APPLICATIONS

The present application claims priority to Ukrainian Patent Application No. u201010957 filed Sep. 13, 2010, the entire contents of which are incorporated herein by reference.

### FIELD OF INVENTION

This invention relates to methods of marketing and social research, while informing consumers and/or users with respect to a specific product or service with using telecommunications devices of communication, and may be used to form a database of prospective customers and/or users of a specific product or service, to advertise for users of a specific product or service as well as to transmit information materials relating to a specific product or service to prospective consumers and/or users.

### BACKGROUND

Many methods are known for dissemination of information about a product or service to improve awareness of consumers and/or users, among which the following one is closest at the aggregate of essential features.

It is known to disseminate information about a product or service to improve awareness of consumers and/or users, which includes assigning an individual code to each of the products or services, the carrying out of a survey among participants—subscribers of mobile communication devices through the distribution of products or services with an individual code, the receipt of a notice containing the reply of a subscriber with information on a product, if the subscriber has purchased the product, or a service, should the subscriber use it, from the subscriber's mobile communication device, the formation of a database by subscribers' replies received, the splitting of the database into separate databases according to certain types of information, in which, for example, a customer of data collection is interested. A similar method additionally includes a preparatory stage which involves the preliminary formation of databases according to certain types of information, filled in when the information concerning a product or service is received from subscribers, and includes an encouragement stage which assumes prize drawing among participants in the survey, being subscribers whose identification is made by the numbers of their mobile phones (patent of Ukraine No. 11541 for utility model “Method of marketing and social research”, published in bulletin No. 12 on 15 Dec. 2005).

### SUMMARY

The method described may be applied to a quite broad spectrum of marketing or social researches carried out for a specific product or service. The disadvantage of the well-known method is relatively insufficient motivation of participants in the survey—mobile communication device subscribers—due to the mandatory requirement to purchase a specific product or service and the need to independently send an initial notice containing the reply of a subscriber with the information about a product or service. Besides, the subscriber, in the method described, only sends a notice containing the reply without getting the specific information regarding the same product or service on his mobile communication device, which would be an extra incentive for him in using the method and also would act as a source of information such as improvement of professional knowledge, particularly in that industry to which the product or service belongs.

In one embodiment the method of dissemination of information about a product or service to improve awareness of consumers and/or users, which includes manufacturing of audio visual text materials of advertising and/or informative and/or entertaining nature, containing the information about carrying out the survey, their distribution among prospective consumers or users of products or services, who are subscribers of mobile communication devices, receipt of a message containing a request and/or confirmation from the subscriber's mobile communication device of receiving the message from a wireless data exchange module which is installed permanently or moved by a motor vehicle, sending a message which content is related to a specific product or service to the subscriber's mobile communication device. When doing this, a statistical database on communication sessions with the subscriber is formed at the same time (patent of Ukraine No. 31149 for utility model “Method of Data Exchange”, published in bulletin No. 6 on 25 Mar. 2008).

According to one embodiment, the method may be carried out the collection of information on awareness of consumers and/or users in respect of a product or service with further formation of a database, the informing of consumers about a specific product or service and providing of useful information about a specific product or service in files sent by wireless data exchange module. The disadvantage of the prototype is a relatively narrow scope conditioned by use of connection of the wireless data exchange module and the subscriber's mobile communication device, not allowing to use this method, for example, for collection of information through the Internet or getting by a user the information remotely not in the time when the wireless data exchange module is active, or by the need for the subscriber to be within the working range of this module or generally by the necessity for the subscriber to have a mobile communication device with him. At the same time only sending the subscriber a message thematically related to a specific product or service to the subscriber's mobile device does not allow enhancing of motivation of the subscriber to further get information about a specific product or service.

The objective of creation and/or improvement of state of awareness of a subscriber being a prospective consumer and/or user in respect of a product or service by receipt of information through the interactive voice system IVR in respect of a specific product or service, in particular, medications, medical products, medical equipment, diagnostic methods, treatment, prevention, rehabilitation, medical or pharmaceutical services is taken as the basis of the utility model.

The objective set is achieved by that in the method of dissemination of information about a specific product or service to improve awareness of consumers and/or users, which involves the manufacturing of audio visual text materials of advertising and/or informative and/or entertaining nature, containing the information about carrying out the survey, their distribution among prospective consumers or users of a product or service, who are subscribers of devices of telecommunication means of communication, receipt of a message containing a request and/or confirmation of consent to participation in the survey from the subscriber's device of telecommunication means of communication, sending a message containing a query or task relating to a product or service to the subscriber's device of telecommunication means of communication, receipt of a message containing the subscriber's reply to the query or task relating to a product or service from the subscriber's device of telecommunication means of communication, according to the utility model, the subscriber's reply to the query and/or task relating to a product or service is assessed, a message containing the information about providing the subscriber with an award according to the results of the subscriber's reply to the query and/or task is sent, a database containing at least the information about the subscribers that made a request to participate in the survey is formed, a subscriber is informed about a possibility to address the interactive voice system IVR with a request for provision of extra information on the query and/or task relating to a product or service, received by him, the subscriber is provided, through the interactive voice system IVR, with the reference information on the query and/or task relating to a product or service as a response to the subscriber's request.

A subscriber's mobile terminal may be used as a device of telecommunication means of communication.

A subscriber's fixed-line telephone terminal may be used as a device of telecommunication means of communication.

A personal computer with access to the Internet may be used as a subscriber's device of telecommunication means of communication by sending and receiving electronic messages.

A personal computer with access to the Internet may be used as a subscriber's device of telecommunication means of communication by sending and receiving messages through electronic forms posted on the web-page of website containing information about a product or service.

A personal computer with access to the Internet may be used as a subscriber's device of telecommunication means of communication by sending and receiving messages through an interactive web-site for communication of Internet users.

Text or multimedia messages of the mobile communication network may be used as messages.

It is also may be sent messages containing the information about providing a subscriber with an award as recharging the subscriber's account in the mobile communication network.

It is also may be sent messages containing queries and/or tasks on medications, medical devices, medical equipment, diagnostic methods, treatment, rehabilitation, prevention, medical or pharmaceutical services.

It is also may be sent messages containing queries and/or tasks of clinical nature on medications, medical devices, medical equipment, diagnostic methods, treatment, prevention, rehabilitation, medical or pharmaceutical services.

A subscriber may be also provided with reference information containing a reply to a query and/or task with using a voice message or text message or graphic message or unified resource locator (URL).

There are cause-effect relations between the aggregate of essential features of the present invention and technical result, which is achieved.

The manufacturing of audio visual text materials of advertising and/or informative and/or entertaining nature, containing the information about carrying out the survey and their distribution among prospective consumers or users of products or services, who are subscribers of devices of telecommunication means of communication, allows the preliminarily informing of prospective consumers or users of products or services about a possibility to get information relating to a specific product or service through participation in the survey, about provision of a subscriber with an award according to the results of the subscriber's reply to the query and/or task on survey.

The receipt of a message containing a request and/or confirmation of consent to participation in the survey from the subscriber's device of telecommunication means of communication, sending a message containing a query or task relating to a product or service to the subscriber's device of telecommunication means of communication and receipt of the subscriber's reply to the query or task relating to a product or service from the subscriber's device of telecommunication means of communication enable to ensure the collection of information on awareness of consumers and/or users in respect of a product or service to form a database containing at least the information about the subscribers that made a request to participate in the survey and to ensure the receipt of information by a subscriber of device of telecommunication means of communication as a prospective consumer or user on specific products or services, in particular for his learning, getting professional knowledge by him etc.

The performance of assessment of a subscriber's reply to a query and/or task relating to a product or service and sending a message containing the information about providing the subscriber with an award according to the results of the subscriber's reply to the query and/or task enables to increase a level of encouragement of subscribers of device of telecommunication means of communication as prospective consumers or users to participation in the survey and to prolong the subscribers' participation in the survey as well as to expand the options of collecting the information on awareness of consumers and/or users in respect of a product or service.

The formation of a database containing at least the information about the subscribers that made a request to participate in the survey enables obtaining a database that may be used for communication with the subscribers by sending out advertisement messages (at a subscriber's consent etc.).

The informing of a subscriber about a possibility to address to the interactive voice system IVR with a request for provision of reference information about a query and/or task in respect of a product or service received by him and provision of the subscriber through the interactive voice IVR system with the reference information about the query and/or task in respect of a product or service as a response to the subscriber's request enables to ensure an additional form of receipt of specialized information about a product or service, for example, to improve his own professional knowledge, which is an additional form of learning. Thus, use of the voice system IVR enables to simplify the implementation of an additional form of receipt of specialized information and to ensure its reliable and round-the-clock provision.

The usage, as a device of telecommunication means of communication, of a subscriber's mobile terminal or a subscriber's fixed-line telephone terminal or a personal computer with access to the Internet by sending and receiving electronic messages or a personal computer with access to the Internet by sending and receiving messages through electronic forms posted on the web-page of website containing information about a product or service, or a personal computer with access to the Internet by sending and receiving messages through an interactive web-site for communication of Internet users enables to expand the scope of the claimed method and to increase a level of encouragement of subscribers of devices of telecommunications means of communication.

The usage, as messages, of text or multimedia messages of the mobile communication network enables to transmit text, graphic or multimedia information on a product or service, which will increase a level of encouragement and informing of subscribers.

The sending of a message containing the information on providing a subscriber with an award as recharging the subscriber's account in the mobile communication network enables to increase a level of encouragement of a subscriber and simplifies the implementation of the method.

The sending of a message containing queries and/or tasks concerning medications, medical devices, medical equipment, diagnostic methods, treatment, prevention, rehabilitation, medical or pharmaceutical services enables to implement the method of collecting the information on awareness of consumers and/or users in respect of specific products or services, particularly in medical or pharmaceutical industries, as well as to establish a telecommunication channel for provision of information to physicians of various specialties, medical technicians, pharmacists and pharmaceutical chemists, for improvement of their professional knowledge relating to the exercising of professional duties in the medical and pharmaceutical industry, which results in arrangement of remote learning.

The usage of tasks of clinical nature, concerning medications, medical devices, medical equipment, diagnostic methods, treatment, prevention, rehabilitation, medical or pharmaceutical services enables to increase a level of encouragement of subscribers who can be physicians of various specialties, medical technicians, pharmacists and pharmaceutical chemists and to improve the learning by them of information that they receive along with a message containing a query or task concerning a product or service because the subscribers have to not only provide a positive or negative reply to the query or task concerning a product or service, but to apply their knowledge and skills, especially on account of use of a specific product or service if consumers and/or users are familiar with them. At the same time, the information on awareness of a subscriber or a group of subscribers in respect of a specific product or service may be stored on forming a database.

The provision of a subscriber with reference information containing a reply to queries and/or tasks with using a voice message or text message or graphic message or unified resource locator (URL) enables to broaden a range of types of information, which would result in raising the degree of awareness of a consumer and/or user in respect of a product or service.

### DETAILED DESCRIPTION

To explain the essence of this invention, an example of specific implementation of the method of collecting the information on awareness of consumers and/or users in respect of a product or service is given below. The given example of specific implementation of the method limits in no way the scope of the claims set forth in the formula, and only explains the essence of the utility model.

Thus in the specified method the term “consumer of products or services” implies the end consumer of a product or service, such as a buyer of medications or a visitor to a medical institution when the method is used in the medical and pharmaceutical industry. The term “user of products or services” implies a person who should be aware of a product or service through his activities, such as physicians of various specialties, medical technicians, pharmacists and pharmaceutical chemists when the method is used in the medical and pharmaceutical industry. The term “awareness of a product or service” implies awareness, availability of certain knowledge and skills with consumers and/or users when using specific products or services. The term “interactive voice system IVR” (Interactive Voice Response) implies a system of preliminarily recorded voice messages implemented with, for example, an answer-back unit.

The claimed method is implemented, for example, in the pharmaceutical industry as follows.

First, it produces some materials of advertising and/or informative and/or entertaining nature, containing the information about carrying out the survey. Those materials may be printed articles, in particular, booklets, catalogues, brochures or video products, such as a commercial or e-mail on the Internet and so on. Then the materials produced are distributed among prospective consumers or users of products or services in places of holding the thematic conferences or workshops, through the mass media or Internet. The prospective consumers or users of products or services as subscribers of devices of telecommunication means of communication are therefore made informed about carrying out the survey. The materials produced may also contain the information for a subscriber about a possibility to address to the interactive voice system IVR with a request on provision of reference information about a query and/or task in respect of a product or service, received by him. Such informing may be done both at this stage and at each of the next stages of survey and informing.

A database containing messages with a query or task concerning a product or service is preliminarily formed. Such queries or tasks may be, for example, use of medications or biologically active additives (BAA), curative cosmetics, medical appliances, including all aspects, i.e. manner of use, indications for use, contraindications, distinctive features of use, dosages etc), other aspects relating to use of the above, their use for various diseases and conditions that require medical intervention. Queries or tasks may relate to diagnosis and treatment of diseases and conditions that require medical advice and intervention, consultation of pharmaceutical chemists or pharmacists, should a doctor's advice be optional (according to the principles of appropriate self-treatment with medicinal preparations dispensed without prescriptions, BAA or curative cosmetics).

### Example of a Query No. 1

Query: “spectrum of hepatoprotective activity of the medication (product name) allows its use for patients with the following diagnoses:

Options of reply:
hepatic steatosis
toxic affection of liver
acute and chronic hepatitis
psoriasis
radiation syndrome
cirrhosis
all listed above.”

### Example of a Query No. 2

Query: “a patient is of 30 years old, diagnosed with antibiotic-associated diarrhoea. What dose of the medication (product name) would you prescribe for this patient?

Options of reply:
1 vial 2-3 times a day
1 vial once a day
2 vials once a day.”

A database containing a message with reference information about a query and/or task in respect of a product or service for the interactive voice system IVR and other voice messages of advertising or informative nature for IVR system, needed for communication with a subscriber, is also formed.

An example of the reference information (see a query or task No. 1) is as follows.

“According to the instruction for medical use, the medication (product name) is used for: hepatic steatosis (including affection of liver on diabetes), acute and chronic hepatitis, cirrhosis, pre- and post-operative treatment of patients upon surgical intervention in bile-excreting passages, toxic affection of liver, toxemia of pregnancy, psoriasis, radiation syndrome”.

An example of the reference information (see a query or task No. 2) is as follows.

“According to the instruction for medical use of probiotic-bioenteroseptic medication (product name), it is used a dosage for children under 16 and adults: 1 vial 2-3 times a day.”

Then the subscriber sends a message containing a request to a service provider company, such as a mobile communication operator, from a mobile terminal as a text message (SMS, Short Message Service) or a multimedia message (MMS, Multimedia Message Service).

Then the subscriber is sent a message containing a query and the subscriber's reply to the query or task in respect of a product or service is received from the subscriber's device of telecommunication means of communication, if he takes part in the survey. Next, the subscriber's reply to the query and/or task in respect of a product or service is assessed by comparing the subscriber's reply with the correct replies and assigning to the mobile communication subscriber an appropriate award through a mobile operator, such as points equivalent to currency unit or as recharging the subscriber's account in the mobile communications network.

Then a message containing the information about providing the award is sent to the subscriber. A database containing the information about the subscribers made a request to participate in the survey with computer's data storage means, such as electronic storage media is also be formed. Those data may be either the numbers of subscribers' mobile terminals and their personal data, if personification of subscribers has been previously done, or the survey data for each of the subscribers or a group of subscribers and so on. The database so formed may be further used for next surveys, informing of consumers and/or users or advertising mailing at consent of a subscriber.

At that, when a subscriber addresses the interactive voice system IVR to get the reference information on a query and/or task relating to a product or service, received by him, such information is sent to the subscriber through the interactive voice system IVR or by transmitting a message to a telecommunication terminal with using a voice message or text message or graphic message or unified resource locator (URL).

Thus, use of the claimed method shall ensure the creation and/or improvement of state of awareness of a subscriber being a prospective consumer and/or user in respect of a product or service by receipt of information through the interactive voice system IVR in respect of a specific product or service, in particular, medications, medical devices, medical equipment, diagnostic methods, treatment, prevention, rehabilitation, medical or pharmaceutical services. Thus, a subscriber gains necessary knowledge about products or services for use in his professional activities.

1. A method of dissemination of information about a product or service to improve awareness of consumers and/or users comprising,
manufacturing of audio visual text materials of advertising and/or informative and/or entertaining nature containing;
the information about carrying out a survey, and
the distribution among prospective consumers and/or users of a product or service, who are subscribers of devices of telecommunication means of communication;
receiving a message containing a request and/or confirmation of consent to participation in the survey from the subscriber's device of telecommunication means of communication;
sending a message containing a query or task relating to a product or service to the subscriber's device of telecommunication means of communication;
receiving a message containing the subscriber's reply to the query or task relating to a product or service from the subscriber's device of telecommunication means of communication;
assessing the subscriber's reply to the query and/or task relating to a product or service;
sending of a message containing the information about providing the subscriber with an award according to the results of the subscriber's reply to the query and/or task;
forming a database containing at least the information about the subscribers that made a request for participation in the survey;
informing a subscriber about a possibility to address an interactive voice system IVR with a request for provision of reference information on the query and/or task relating to a product or service received by the subscriber; and
providing the subscriber through the interactive voice system IVR with the reference information on the query and/or task relating to a product or service as a response to the subscriber's request.

2. The method as claimed in claim 1 further characterized in that a subscriber's mobile terminal is used as a device of telecommunication means of communication.

3. The method as claimed in claim 1 further characterized in that a fixed-line telephone terminal is used as a device of telecommunication means of communication.

4. The method as claimed in claim 1 further characterized in that a personal computer with access to the Internet is used as a subscriber's device of telecommunication means of communication by sending and receiving electronic messages.

5. The method as claimed in claim 1 further characterized in that a personal computer with access to the Internet is used as a subscriber's device of telecommunication means of communication by sending and receiving messages through electronic forms posted on a web-page of a website containing information about a product or service.

6. The method as claimed in claim 1 further characterized in that a personal computer with access to the Internet is used as a subscriber's device of telecommunication means of communication by sending and receiving messages through an interactive web-site for communication of Internet users.

7. The method as claimed in claim 2 further characterized in that text (SMS) or multimedia (mms) messages of the mobile communication network may be used as messages.

8. The method as claimed in claim 2 further characterized in that the sending of a message containing the information about providing the subscriber with an award as recharging the subscriber's account in the mobile communication network is carried out.

9. The method as claimed in claim 1 further characterized in that the sending of a message containing a query and/or task on medications, medical devices, medical equipment, diagnostic methods, treatment, rehabilitation, prevention, medical or pharmaceutical services is carried out.

10. The method as claimed in claim 1 further characterized in that the sending of a message containing a query and/or task of clinical nature on medications, medical devices, medical equipment, diagnostic methods, treatment, rehabilitation, prevention, medical or pharmaceutical services is carried out.

11. The method as claimed in claim 1 further characterized in that provision a subscriber with reference information containing a reply to a query and/or task with using a voice message or text message or graphic message or unified resource locator (URL) is carried out.
